(19) United States
(12) Patent Application Publication
(10) Pub. No.: US 2014/0212549 A1
(43) Pub. Date: Jul. 31, 2014

(54) EXTENDED SHELF LIFE MICROGREEN PRODUCTS AND METHODS

(71) Applicant: Fresh Origins, LLC, San Marcos, CA (US)

(72) Inventor: David G. Sasuga, Vista, CA (US)

(73) Assignee: Fresh Origins, LLC, San Marcos, CA (US)

(21) Appl. No.: 14/162,684

(22) Filed: Jan. 23, 2014

Related U.S. Application Data
(60) Provisional application No. 61/757,047, filed on Jan. 25, 2013.

(51) Int. Cl. A23L 1/221

(52) U.S. Cl. CPC A23L 1/221
USPC 426/106; 426/665; 426/416; 426/392; 426/615; 426/638

(57) ABSTRACT

A microgreen product and a method relate to a microgreen characterized by a husky, shorter, thicker main stem reaching a harvested height of about one inch, with larger leaves, and is further characterized by a deeper color of green or red with a more intense taste and longer shelf life, such as at least ten days.

### FIELD OF THE INVENTION

The present invention relates in general to improved microgreen products and methods for extending the shelf life thereof. It more particularly relates to methods for providing microgreen products with significantly longer shelf life than most other microgreens products.

### BACKGROUND ART

This section describes the background art of the disclosed embodiment of the present invention. There is no intention, either express or implied, that the background art discussed in this section legally constitutes prior art.

Microgreens, also called micro greens, are a tiny form of young edible greens produced from various kinds of vegetables, herbs or other plants. They may range in size from about one inch to about 1½ inches including the stem and leaves. Microgreens can have surprisingly intense flavors considering their small size.

Microgreens are used in a variety of ways, primarily in fine dining restaurants. They can be used as a fresh flavor accent to complement and enhance both the flavor and presentation of their dishes. Microgreens have a delicate, fresh appearance that adds beauty and dimension combined with a range of distinct flavor elements to a wide array of foods. In a recent study, microgreens have been found to contain higher levels of nutrients than full sized greens and thus may be used to supplement a healthy diet on their own or to increase the healthful benefits of foods with which they may be combined.

Microgreens have been produced in the United States since about the mid 1990's beginning in Southern California. Initially, there were very few varieties offered. The basic varieties are Arugula, Basil, Beets, Kale, Cilantro and a mixture that later became known as “Rainbow Mix.” They are now being grown in most areas of the country with an increasing number of varieties being produced. Microgreens are still considered a relatively new crop and are not yet widely grown in mass production primarily due to their delicate and highly perishable nature. Microgreens have not been extensively studied or analyzed and there are no associations or cooperating groups of microgreen growers.

Guidance is available for pre-harvest and post-harvest treatments, and post-harvest handling systems, for mature leafy vegetables such as lettuce, cabbages, Chinese cabbage, Brussels sprouts, rhubarb, celery, spinach, chard, kale, endive, escarole, green onions, chicory, radicchio, and other leafy greens, for stem vegetables such as asparagus, kohlrabi, and fennel, and for floral vegetables such as artichokes, broccoli, and cauliflower. For example, guidance is available online at http://postharvest.ucdavis.edu/ and in U.S. Pat. Nos. 2,698,804; 3,987,208; 5,316,778; and 6,470,795, inter alia, which disclose methods, packaging, and apparatus for processing common varieties of mature leafy vegetables to extend storage life. Also, U.S. Pat. Nos. 7,981,454 7,935,375; 6,203,833; and 5,198,254, which inter alia, disclose protective coatings for use on mature vegetables.

In contrast, no prior published studies relating to improving the shelf life of microgreens are currently known. No reports are known of microgreen growers who have grown or marketed separate varieties or any mixture of varieties of microgreens that are said to be longer lasting than is typical of any other microgreens they produce.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a graph illustrating a shelf life observation trial to determine shelf life for certain varieties of microgreens according to an embodiment; and

FIG. 2 is a graph illustrating a shelf life enhancement trial according to an embodiment.

### DETAILED DESCRIPTION OF CERTAIN EMBODIMENTS

It will be readily understood that the components of the embodiments as generally described and illustrated in the drawings herein, could be arranged and designed in a wide variety of different configurations. Thus, the following more detailed description of certain ones of the embodiments of the kits, components and method of the present invention, as represented in the drawings, is not intended to limit the scope of the invention, as claimed, but is merely representative of the embodiment of the invention.

According to an embodiment, there is provided a microgreen which is characterized by a husky, shorter, thicker main stem reaching a harvested height of about one inch, with larger leaves, and is further characterized by a deeper color of green or red with a more intense taste and longer shelf life.

According to certain embodiments, a system and method is provided for extending the shelf life of microgreens, in particular a system and method of providing a microgreens product with significantly longer shelf life than most other microgreens products, wherein the microgreens product has a shelf life of at least ten (10) days. Non-limiting embodiments provide microgreens products having a shelf life of about ten (10) days, about eleven (11) days, about twelve (12) days, about thirteen (13) days, about fourteen (14) days, about fifteen (15) days, about sixteen (16) days, about seventeen (17) days, about eighteen (18) days, about nineteen (19) days, about twenty (20) days, about twenty-one (21) days, about twenty-two (22) days, about twenty-three (23) days, about twenty-four (24) days, about twenty-five (25) days, about twenty-six (26) days, about twenty-seven (27) days, about twenty-eight (28) days, or longer.

Systems and methods of certain embodiments include one or more of the following measures, especially when used together as an entire system of production, harvest, and packing, to increase shelf life significantly of microgreens and microgreens products that have at least one of the hereinafter described advantages over currently used “conventional” microgreens and conventional microgreen production methods:

selecting microgreen varieties specifically for longer shelf life;

designing mixes that utilize only varieties that have longer shelf life;

planting microgreen seeds with the proper seed density;

growing microgreens with high light levels;

growing microgreens with low levels of fertility;

pre-harvest treatments to reduce bacteria counts;

harvesting when stems and leaves are dry;

quickly cooling after harvest;

post-harvest treatments before packaging;

maintaining proper cooling during packaging;

utilizing well sealed and/or Modified Atmosphere Packaging;

utilizing extra-cold gel-packs within the shipping box; and/or

utilizing dry ice in combination with extra-cold gel-packs.

Microgreens and Microgreens Products

The term “microgreen” refers to a seedling which includes a single central stem and leaves, and which is cut just above the soil line during harvesting. At harvest, the microgreen usually has two fully developed cotyledon leaves and one pair very small, partially developed true leaves, while other embodiments could include cotyledon leaves and no visibly developed true leaves, or fully developed cotyledon leaves and more than two true leaves that may be in different stages of development. The typical stem and leaf configuration for microgreens is usually, but not limited to, about 1 inch to about 1½ inches in height, and about ½ inch to about 1 inch in width across the top and includes the stem, cotyledon leaves and one set of very small, partially developed true leaves. The average crop-time for most microgreens is about 7-14 days from seeding to harvest.

The term “microgreens product” refers to microgreens provided for distribution and consumption. Non-limiting exemplary embodiments of a microgreens product may be microgreens ready to be used in a restaurant setting or microgreens provided to a final consumer for consumption, and may include microgreens in a packaging container.

The seeds used to grow microgreens are the same seeds that are used for full sized herbs, vegetables and greens. It is understood that microgreens are simply the stem with leaves that are harvested as seedlings before they develop into larger plants. Commonly grown plants, also referred to as “varieties,” suitable for microgreens and microgreen production methods include but are not limited to: amaranth, arugula, beets, basil, cabbage, Chinese cabbage, Brussels sprouts celery, chard, chervil, chicory, chives, cilantro, cress, cucumber, endive, fennel, garlic, kale, lavender, mint, mustard, nutmeg, onion, parsley, radicchio, radish, spinach, sorrel, mint, and others.

Commonly grown plants, also referred to as varieties, suitable for microgreens and microgreen production methods, may also be identified by common names, which may vary by region or country, such as kaiware (daikon). As indicated by the non-limiting exemplary list of plants above, plants of different groups, such, for example, as both monocots and dicots, families, genera, and species may have desirable characteristics for microgreens and may be suitable for microgreen production. A skilled grower can identify and select plant families, genera, and species that have desirable characteristics for microgreens and may be suitable for microgreen production methods. In accordance with an embodiment, a skilled grower may identify and select specific plants that have desirable characteristics for microgreens and may be suitable for microgreen production methods, such as cultivars, subtypes, or named or registered plant varieties, such, for example, as Italian Parsley (“Parsley Italian”), Upland Cress (“Cress Upland”) and Curled Parsley (“Parsley Curled”) as disclosed, for example, in the hereinafter presented below examples.

Plants or “varieties” suitable for microgreens and microgreen production methods may be identified and selected on the basis of desired traits, for example, as color such as red or yellow, or mixtures of color. One example may be amaranth microgreens that may have varying shades of red colors, or kaiware microgreens that may have shades of purple, red, and/or maroon. Plants or “varieties” suitable for microgreens and microgreen production methods may be identified and selected on the basis of desired traits such as taste or flavor, including but not limited to one or more of the following: mild flavor, such as chard microgreens with less bitter or astringent flavor or sweet flavor, such as basil with sweet flavor; mature flavor, such as cucumber microgreens with cucumber fruit flavor; intense flavor, such as fennel or chervil or chive microgreens with intense herb flavor; spicy flavor such as kaiware microgreens with spicy radish flavor or wasabi microgreens; and/or surprising flavor, such as mint with citrus flavors, or basil with chocolate or citrus flavors. Several different types of plants or “varieties” may be commonly mixed together to create combinations of tastes (flavors), textures and colors. For each plant or “variety” used for microgreens, a skilled grower may identify and select cultivars, subtypes, sports, named or registered plant varieties, and/or others, that have desirable characteristics for microgreens and may be suitable for microgreen production methods including but not limited to taste or flavor, color, texture, shelf life, disease resistance, and/or stress resistance.

A skilled grower may identify and select mixtures of microgreens having desirable characteristics for microgreens, that may be suitable for the microgreen production methods. A skilled grower may identify and select mixtures of microgreens with non-microgreen components that result in microgreen products having desirable characteristics for microgreens, and that may be suitable for the microgreen production methods. Non-limiting examples of microgreen mixtures, and mixtures of microgreens with non-microgreen components to yield microgreen products having desirable characteristics for microgreens, and that are suitable for the microgreen production methods, are described as follows at www.freshorigins.com, the contents of which are hereby incorporated by reference:

Micro Basil Nutmeg—appealing bright green leaves that release a unique fragrance, wonderful flavor of nutmeg, reminiscent of the holidays;

Micro Cucumber—light green leaves with an attractive smooth texture, having fresh, juicy succulent cucumber flavor;

Micro Mustard Dijon—very attractive microgreen with light green leaves and a snappy personality, actually tastes similar to spicy Mustard Dijon;

Micro Radish Ruby—glamorous dark purple leaves on matching purple colored stems having fresh, spicy radish flavor, rich in antioxidants;

Micro Tangerine Lace—feathery green leaves. Amazing and surprising tangerine zest flavor;

Micro Wasabi—light green leaves to provide a favorable taste comparison with respect to other microgreen growers as having true wasabi flavor, bursting with spicy flavor, similar to eating wasabi root, and may clear the sinuses;

Micro Mint Lime—appealing green leaves with a leasing purple tint, having concentrated flavors of Mint, Lime and other savory notes;

Micro Citrus Mix—mixture of strong citrus flavored herbs such as Basil Lemon, Mint Lemon, Sorrel, Tangerine Lace, and more;

Micro Fines Herbes—a delicate and sophisticated blend based on the classic French herb combination;

Micro Intensity Mix—exceptional combination of about 15 to 20 herbs and greens to provide flavors of herbs, veggies, citrus, licorice, and spicy greens; and/or

Micro Mirepoix—version of the traditional French base for cooking, which may include distinctive flavors of celery, onions and carrots.

Perishability

Conventional microgreens are highly perishable and are known to be fragile having a shelf life of only about 5 to about 10 days. This short shelf life is understood to be a major limitation and detriment in the use and marketing of microgreens, and is an impediment in the distribution to restaurants and retail businesses. This short shelf life requires more expensive expedited shipping. Due to their perishability, conventional microgreens must be consumed within a few days of receipt. If the microgreens are not consumed within this short window of time, they will probably need to be discarded often resulting in more waste than necessary. Microgreens that reach the end of their period of freshness begin to lose flavor, the color begins to change, and they begin to rot. Once this process begins, it progresses very rapidly rendering the microgreens unfit for use.

In contrast, regular sized leafy greens (from intermediate to mature leafy greens) such as lettuce-based salads are produced and marketed according to a model that is based upon having a minimum of about 14 days shelf life for the intermediate to mature leafy greens to go through the distribution and transportation channels from farm to packing house to grocery store to the final consumer's home and into their meal, or in the case of restaurants to the final consumers' plate. If the shelf life of microgreens could be significantly improved, they could be used as an important component/ingredient of regular leafy greens/lettuce based salads that could then be distributed through the very efficient channels of distribution currently used for regular leafy greens to a mass market of consumers. Prior to the present disclosure, this is not currently being done due to the highly perishable nature of microgreens.

Although microgreens are grown and sold in several different separate varieties, the bulk of microgreens are sold and used in the form of mixtures of various microgreen varieties mixed together in a single container. Currently, the most common mixture is called “Micro Rainbow Mix” and consists of 4 to 6 different varieties of microgreens. The typical components of Micro Rainbow Mix are, but are not limited to, arugula, beets, broccoli, cabbage, kale, radish and amaranth. There may be variations of this that include the use of other varieties such as cilantro, basil, chard, mizuna, or tatsoi. The shelf life of these mixes may be determined by the variety that has the shortest shelf life, or in other words, the component of the mix that is first to rot, will cause the mix to be unusable even if other components are still not yet rotting. Additional description and non-limiting examples of microgreen mixtures are previously described. As presently understood, there have not been any published studies done relating to improving the shelf life of microgreens, and there have not been any microgreen growers who have grown or marketed separate varieties or any mixture of varieties of microgreens that are said to be longer lasting than is typical of any other conventional microgreens they produce.

By determining the specific varieties of microgreens that have longer shelf life, it is possible to market the longer lasting separate varieties or mixtures of these microgreens to take advantage of more economical and far-reaching channels of distribution resulting in greater profitability and increased sales.

We have conducted shelf life testing of the major varieties of microgreens. We have determined which varieties possess significantly longer shelf life than most other varieties. We have also created mixes of the longest lasting varieties that significantly outlast the typical microgreens mix. Selecting specific varieties of microgreens that have the longest shelf life creates significant advantages in the marketplace over microgreens that have not been selected for this trait. Selecting specific varieties of microgreens for longer shelf life results in significant benefits to the grower, distributor, restaurant or retailer, and consumer.

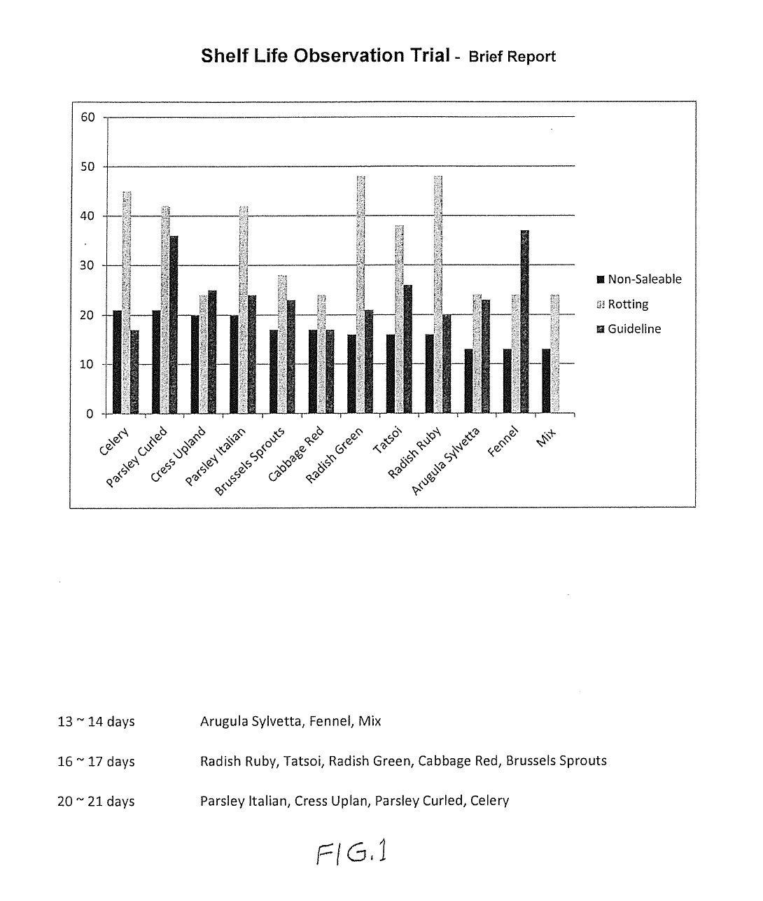

As a test, as shown in FIG. 1 we selected varieties of microgreen products and undertook an observation trial. A sample of each variety was packaged in an eight-ounce clamshell package (not shown). Also, two eight ounce clamshell packages (not shown) were used to store and observe a mixture of all of the varieties tested.

Eleven different varieties were observed subjectively in the test, and it was noted that each variety reacted at least somewhat differently. The tester subjectively determined when each variety became unsalable with the passage of time. It was also noted when each variety finally deteriorated to the point of rotting. As shown in FIG. 1, a graph illustrates the condition of each one of the varieties as well as the mixture with the passage of time. As noted in FIG. 1 Parsley Italian, Cress Upland, Parsley Curled, and Celery had the longest shelf life of between 20 and 21 days.

Cultural growing practices of microgreens can also result in longer or shorter shelf life. We have determined that high light levels during the growing of microgreens produces a stronger, longer lasting and more flavorful microgreens than those grown under lower light conditions or artificial lights.

We have determined that microgreens grown with excessive seed density results in crowded conditions that cause soft elongated or stretched stems and smaller leaves. Microgreens grown with excessive seed density have shorter shelf life than those grown with lower seed densities.

We have determined that microgreens that are grown with high levels of fertility results in soft elongated growth and soft leaves. Microgreens grown with high levels of fertility have shorter shelf life than those grown with lower fertility levels.

Utilizing certain, unique pre-harvest methods are also valuable tools that may be used to increase shelf life. Microgreens are harvested by cutting the base of the stem to separate them from the roots. The following methods may be used to improve the shelf life of microgreens.

Making reasonably certain that the microgreens are dry before harvesting results in longer shelf life compared to microgreens that are harvested when wet. When microgreens are irrigated it may take several hours before the stems and leaves are dry. When microgreens are subjected to high humidity levels, the stems and leaves may be wet. By making reasonably certain the stems and leaves are completely dry prior to being harvested the shelf life is improved.

Microgreens that are pre-treated with certain materials to reduce bacteria may significantly increase shelf life by limiting the rotting that occurs. Examples of such materials are sanitizing agents that are designed to kill bacteria that aid in rotting. Such sanitizing agents are sprayed onto the microgreens to reduce bacterial content several hours before the harvest so that the microgreens are sufficiently dry upon harvesting. Other materials may increase shelf life by creating a protective barrier on the surface of the microgreens.

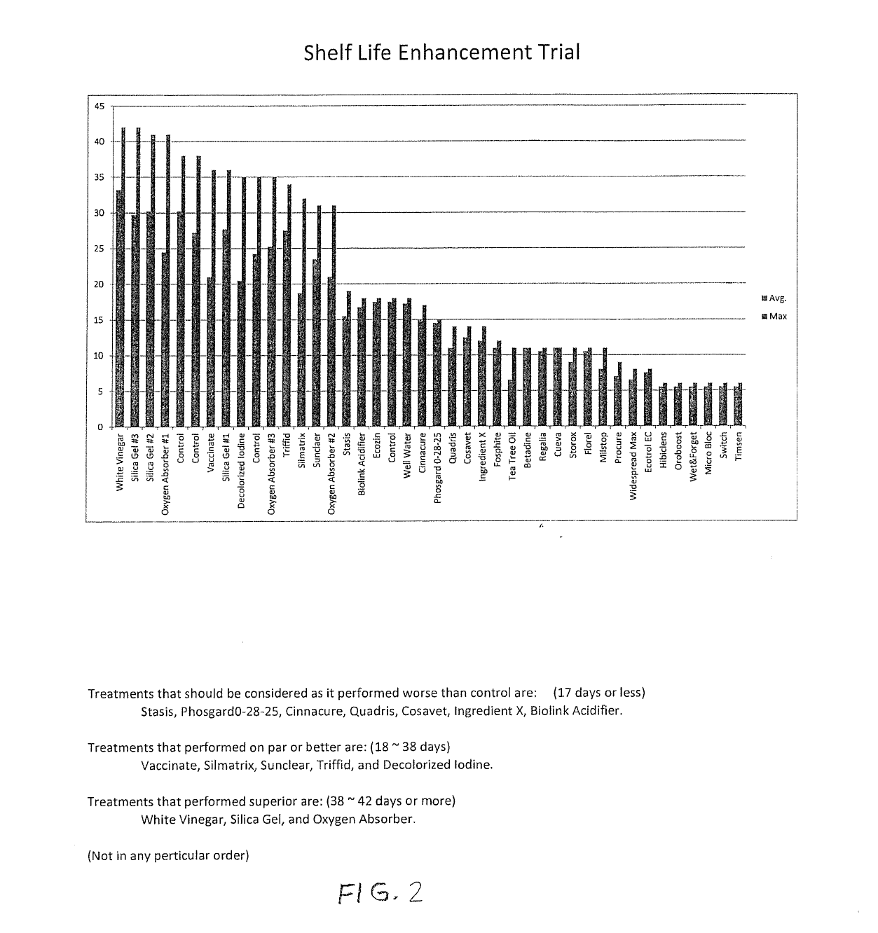

Referring now to FIG. 2, we conducted a shelf life enhancement test which included pretreating micro arugula with sanitizing agents sprayed onto the micro arugula to reduce bacterial content several hours before the harvest. The sanitizing agents were identified after numerous trials and studies. We selected 33 different enhancing agents with varying concentration levels as indicated in FIG. 2.

After applying the treatments, each one of the pretreated micro arugula plants were harvested after drying for a few hours and placed in two four-ounce clamshell packages for observation. During the following day, the pretreated micro arugula was again harvested a second time and placed in two additional four-ounce clamshell packages for observation and comparison. The trial also included five groups of four-ounce clamshell packages containing control groups of untreated micro arugula. There were a total of 160 four-ounce clamshell packages being individually observed subjectively. A different tester this time observed the harvested plants from a more liberal subjective point of view. This tester was observing the harvested micro arugula for a complete decay of the product, which may be beyond the salable point.

Most of the treated samples performed worse than the control groups. This may have been caused by the chemicals or agents which may have degraded the plants and caused early spoilage or decay. As indicated in FIG. 2, there were five sanitizing agents that performed on par or better for a shelf life of between 18 and 38 days. Treatments that performed in a superior manner were white vinegar, silica gel, and oxygen absorber, which provided an extended shelf life of between 38 days and 42 days or more. Post-harvest treatments may also significantly increase the shelf life of microgreens. Following harvest, it often takes several hours for microgreens in harvest containers to cool down to 35-40 degrees Fahrenheit. Quickly cooling microgreens to 35-40 degrees Fahrenheit after harvesting may reduce stress and wilting and thus results in improved shelf life over microgreens that have not been quickly cooled to 35-40 degrees Fahrenheit after harvest.

We have found that quickly cooling microgreens after harvest may require special facilities and equipment designed specifically for this purpose. Other microgreen growers may not have the knowledge, facilities or capabilities to cool quickly after harvest, thereby resulting in shorter shelf life than may be achieved with proper cooling.

Microgreens may be treated with antibacterial agents after harvesting has occurred. This treatment may result in improving shelf life.

It should be noted that microgreens as presently disclosed are not the same as “sprouts” that have different composition, different production methods, and lack many of the properties of microgreens as presently disclosed. Briefly, sprouts are simply germinated seeds, and what is eaten consists of the seed, root, stem and pale, underdeveloped leaves. Seeds used to product sprouts are not actually planted. Sprouts are produced in water or on water-saturated substrates, or in very-high-humidity conditions, such that seeds germinate rapidly due to resulting high moisture and humidity levels. Sprouted seeds are generally sold as a tangled mass of very pale roots, stems and leaf buds. There are significant safety concerns about the safety of sprouts in view of outbreaks of food poisoning worldwide.

Without wishing to be limited by this disclosure, presently microgreens cannot be grown using the methods for producing sprouts. Microgreen seeds are planted and grown in soil or a soil substitute such as peat moss, or other fibrous materials. They are ideally grown in high light conditions with low humidity and good air circulation. The seed density is a fraction of what is used in sprout processing so each individual plant has space in which to grow and develop. Most varieties require 1 to 2 weeks growing time, and some require 4 to 6 weeks. After the leaves are fully expanded the microgreens may be ready for harvest. They are cut above the soil surface and packed without any roots. Some micro greens may be sold while still growing, rooted in soil or other growing medium, so that they can be cut by the end user. If the stem is cut leaving root behind, and it is not produced in water, it is a microgreen, not a sprout. Microgreens that are grown in sunlight with plenty of space and good ventilation may have increased vigor resulting in more color and flavor as compared to those grown under artificial lights. The conditions that are ideal for growing microgreens usually do not encourage the growth of dangerous pathogens. These growing methods would not work for the production of sprouts.

Packaging and Shipping to Improve Shelf Life

After harvest, cool temperatures of 35 to 40 degrees Fahrenheit may be maintained without interruption during packaging to keep the microgreens fresh. Packaging is the placement of harvested microgreens into their final container. This may be done within a cooled environment. Microgreens may be packed in rigid plastic clamshell containers or bags. These containers may provide protection against crushing. The design of the container may also have an effect on shelf life. Clamshell containers that limit the amount of air exchange may offer improvements in shelf life as compared to clamshell containers that have higher rates of air exchange. Modified Atmosphere Packaging may also improve shelf life by managing the respiration rate of the greens within the package. Modified Atmosphere Packaging may also improve shelf life with the introduction of certain levels of nitrogen gas.

Microgreens may be shipped in cardboard boxes (not shown) lined with an insulating material such as Styrofoam or bubble wrap. The microgreens are kept cool during boxing and shipping within the cardboard shipping box by including pre-cooled gel-packs in the box. Gel-packs contain a liquid that, when frozen, will harden to a solid state. Once they are frozen, they are ready to use. We have discovered that while gel packs will freeze at 30 degrees Fahrenheit and harden enough for use in cooling, they may be further cooled to temperatures in the range of minus 15 to 20 degrees Fahrenheit. These extra-cold gel-packs will stay colder and last longer during shipping in the box than normally cooled gel-packs, resulting in better shelf life for the microgreens.

We have found that the cooling ability of regular gel-packs may be improved by the addition of dry ice. If packages of dry ice are used in conjunction with the gel-packs, the gel-packs may stay cold longer and this combination may result in maintaining more consistent temperatures within the shipping box for an extended period of time as compared to not having the dry ice. Dry ice should be used with care to prevent freezing of the microgreens. If microgreens are frozen they may not be usable and will have to be discarded. No reports are known of other growers of microgreens who have utilized extra-cold gel-packs or dry ice for shipping.

The novel microgreens may be stored and shipped as a microgreen salad kit. The kit (not shown) may include a large clam shell container or other type of container such as a bag, confining a salad mixture of leafy greens, and a small clam shell container confining at least one variety of microgreens having a long shelf life. The small container or bag may be disposed within the large container with the mixture of leafy greens.

A present embodiment of a microgreen is a microgreen characterized by a husky, shorter, thicker main stem reaching a harvested height of about one inch, with larger leaves, and is further characterized by a deeper color of green or red with a more intense taste and longer shelf life.

While particular embodiments of the present invention have been disclosed, it is to be understood that various different modifications and combinations are possible and are contemplated within the true spirit and scope of the disclosed embodiments. There is no intention, therefore, of limitations to the exact disclosure herein presented.

What is claimed is:

1. A method of providing a microgreens product with significantly longer shelf life than most other microgreens products, wherein the microgreens product has a shelf life of at least ten (10) days.

2. The method of claim 1, comprising identifying at least one variety of microgreens having significantly longer shelf life than most other varieties, and selecting the at least one variety for use in the microgreens product.

3. The method of claim 2, further wherein the microgreens product includes a mixture of varieties of microgreens, comprising identifying varieties of microgreens having similar shelf life, and selecting a mixture of varieties of microgreens having similar shelf life for use in the microgreens product.

4. The method of claim 1, comprising at least one of the following prior to harvesting the microgreen for use in the microgreens product:
(a) identifying the microgreen density that results in significantly longer shelf life for a variety, and growing the microgreen seedlings of that variety at that density;
(b) growing the microgreen under conditions of high light intensity;
(c) growing the microgreen under conditions of low soil fertility;
(d) treating the microgreen with at least one sanitizing agent prior to harvesting;
(e) treating the microgreen with at least one sanitizing agent prior to harvesting to reduce bacteria count, thereby forming a protective barrier on the seedling prior to harvesting; and
(f) allowing sufficient time after irrigation for stems and leaves to dry, wherein the microgreen seedlings are harvested when stems and leaves of the seedlings are dry or substantially dry.

5. The method of claim 1, comprising at least one of the following after harvesting the microgreens for use in the microgreens product:
(a) quick-cooling the microgreens immediately after harvesting;
(b) treating the microgreens with at least one sanitizing agent; and
(c) treating the microgreens with at least one substance that forms a protective barrier; and
(d) maintaining microgreens at a temperature of between 35-40° F. (1.66 to 4.44° C.) without interruption.

6. The method of claim 1, comprising packaging the microgreens to produce the microgreens product, comprising at least one of:
(a) selecting and using packaging containers with limited amount of air exchange;
(b) packaging under Modified Atmosphere Packaging, optionally including nitrogen gas at above ambient levels; and
(c) maintaining microgreens at a temperature of between 35-40° F. (1.66 to 4.44° C.) without interruption during packaging.

7. The method of claim 1, comprising shipping the packaged microgreens product, comprising one of the following:
(a) selecting and using sufficiently insulating shipping containers;
(b) selecting and using cooling materials in the shipping containers, optionally gel packs frozen to a temperature of at least 30° F. (−1.11° C.) or less, and further optionally a combination of frozen gel packs and dry ice (solid CO₂); and
(c) maintaining shipping conditions to maintain the microgreens product at a temperature of between 35-40° F. (1.66 to 4.44° C.) without interruption.

8. A microgreens product having an extended shelf life, prepared by
(a) identifying and selecting at least one variety of microgreens having significantly longer shelf life than most other varieties, for use in the microgreens product;
(b) growing microgreens under conditions of seedling density, high light intensity, and low soil fertility sufficient to produce microgreens of that variety having significantly longer shelf life;
(c) optionally treating the microgreens with at least one sanitizing agent, or at least one substance that forms a protective barrier on the seedling, prior to harvesting;
(d) harvesting when the microgreens are dry;
(e) quickly cooling the microgreens after harvest;
(f) optionally treating the harvested microgreens with at least one sanitizing substance or at least one substance that forms a protective barrier;
(g) packaging the microgreens in a packaging container with limited amount of air exchange and optionally comprising a modified atmosphere, e.g., N₂ gas at above ambient levels, to provide a microgreens product; and
(h) maintaining the microgreens product at a temperature of between 35-40° F. (1.66 to 4.44° C.) without interruption during packaging and shipping.

9. Packaged microgreens product having significantly longer shelf life than most other microgreens products comprising, microgreens of one or more varieties grown and treated under conditions suitable to produce microgreens of significantly longer shelf life from each variety in the product and a packaging container with limited amount of air exchange and optionally comprising a modified atmosphere, e.g., N₂ gas at above ambient levels.

10. The packaged microgreens product of claim 9, further comprising a shipping container sufficient to maintain the microgreens and packaging at a temperature of between 35-40° F. (1.66 to 4.44° C.) without interruption during shipping.

11. A kit comprising:
(a) a large rigid plastic container or bag;
(b) a mixture of mature leafy greens disposed within the large clam shell container or bag;
(c) a small clam shell container or bag disposed within the large clam shell container or bag; and
(d) at least one variety of microgreens having a long shelf life disposed within the small clam shell container or bag.

12. A microgreen harvested from a seedling, comprising: a thicker, husky, shorter main stem reaching a harvested height of about one inch, with larger leaves, and characterized by a deeper color of green or red with a more intense taste and exhibiting a longer shelf life.

13. A microgreen according to claim 12, wherein the microgreen is selected from the group consisting of Parsley Italian, Cress Upland, Parsley Curled and Celery.

14. A microgreen of claim 12, wherein the shelf life is at least ten (10) days.
